(19) United States
(12) Patent Application Publication
(10) Pub. No.: US 2020/0107661 A1
(43) Pub. Date: Apr. 9, 2020

(54) Drinking Straw

(71) Applicant: TAIWAN POWER TESTING TECHNOLOGY CO., LTD., New Taipei City (TW)

(72) Inventor: YU-CHIANG LIN, New Taipei City (TW)

(73) Assignee: TAIWAN POWER TESTING TECHNOLOGY CO., LTD., New Taipei City (TW)

(21) Appl. No.: 16/151,196

(22) Filed: Oct. 3, 2018

(51) Int. Cl. A47G 21/18

(52) U.S. Cl. CPC A47G 21/18; B32B 1/08

(57) ABSTRACT

A drinking straw being formed as a hollow tube having two ends in fluid-communication with each other, the drinking straw comprising: an aluminum foil tubular layer, and a pulp tubular layer attached to the aluminum foil tubular layer in such a manner that one surface of the pulp tubular layer completely overlaps on one surface of the aluminum foil tubular layer.

### FIELD OF THE INVENTION

The present invention relates to a drinking straw, and more particularly relates to a low cost drinking straw.

### BACKGROUND OF THE INVENTION

With the wide-spread use of a drinking straw, there are more researches about the negative impact brought thereby, including in the field of ecology and environment protection as well. In addition to the consideration of drinking straw after use, the producing processes of drinking straw also affect the environment too. In addition, manufacturing cost of drinking straw is another issue that is considered.

In detail, it is difficult to recycle drinking straws because it is small and made of plastic as compared with waste plastic bottles or waste paper. Therefore, the drinking straw is usually dropped out by people. Furthermore, the plastic drinking straw is made of material difficult to be decomposed. Therefore, if enormous plastic drinking straws are dumped into the environment, it will be inevitable to cause a tremendous catastrophe to the ecology. In order to prevent the plastic drinking straw from damaging the environment, the prior art discloses drinking straws made of different material from plastic, such as a stainless steel drinking straw or a glass drinking straws.

Nevertheless, since the high temperature boiler is required for manufacturing the stainless steel drinking straws, it consumes a large amount of energy in the production process and thus causes the extremely high production cost. On the other hand, there requires several processes for manufacturing a glass drinking straw, such as batching, melting, forming, and annealing, such that the production cost for one single glass drinking straw is almost above USD 3.

### SUMMARY OF THE INVENTION

Therefore, an objective of the present invention is to provide a drinking straw which is able to be manufactured in low cost under ecological premise.

In order to solve the abovementioned problem, the present invention provides a drinking straw formed as a hollow tube having two ends in fluid-communication with each other. The drinking straw comprising: an aluminum foil tubular layer and a pulp tubular layer which is attached to the aluminum foil tubular layer in such a manner that one surface of the pulp tubular layer completely overlaps on one surface of the aluminum foil tubular layer.

In one embodiment of the present invention, an inner surface of the aluminum foil tubular layer is attached on an outer surface of the pulp tubular layer.

In one embodiment of the present invention, an outer surface of the aluminum foil tubular layer is attached on an inner surface of the pulp tubular layer.

In one embodiment of the present invention, the drinking straw is formed with two aluminum foil tubular layers between which the pulp tubular layer is formed.

In one embodiment of the present invention, the drinking straw further comprises an internal waterproof layer which is attached on an internal surface of the pulp tubular layer.

In one embodiment of the present invention, the drinking straw further comprises an exterior waterproof layer which is attached on an outer surface of the pulp tubular layer.

In one embodiment of the present invention, the drinking straw further comprises a printed layer formed on an outer surface of the drinking straw.

In one embodiment of the present invention, the printed layer is a waterproof printed layer.

In one embodiment of the present invention, the drinking straw further comprises an exterior waterproof layer which is attached on the outer surface of the printed layer.

In one embodiment of the present invention, the drinking straw further comprises an end waterproof layer which is formed on a periphery of each end of the hollow tube.

By the technical means adopted by the drinking straw of the present invention, the drinking straw is simple and is with advantage for mass production. Furthermore, the drinking straw of the present invention is formed by a multilayer structure which is closely attached on one another. With this kind of structure, the drinking straw is capable of not only maintaining the basic strength in use, but also being squeezed in a impact so as to avoid injury of human being in an accident, such as piercing or cutting.

### BRIEF DESCRIPTION OF THE DRAWINGS

FIG. 1 shows a schematic perspective view of the drinking straw according to one embodiment of the present invention.

FIG. 2 shows the A-A cross-sectional view of the drinking straw according to FIG. 1.

FIG. 3 shows a schematic cross-sectional view of the drinking straw according to another embodiment of the present invention.

FIG. 4 shows a schematic cross-sectional view of the drinking straw according to another embodiment of the present invention.

FIG. 5 shows a schematic view of the drinking straw according to another embodiment of the present invention.

FIG. 6 shows a schematic view of the drinking straw according to another embodiment of the present invention.

### DETAILED DESCRIPTION OF THE PREFERRED EMBODIMENTS

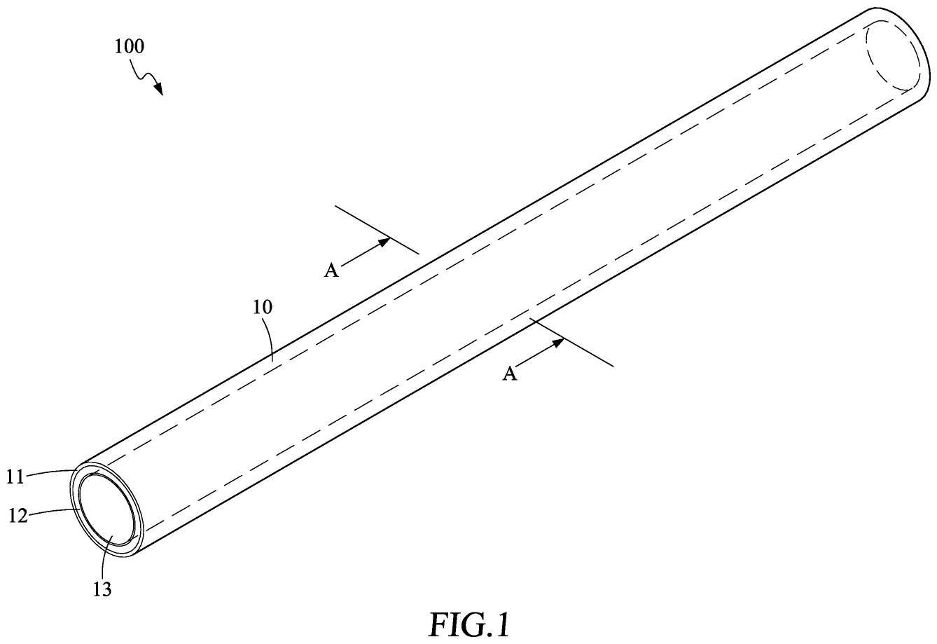

The preferred embodiments of the present invention are described in detail below with reference to FIG. 1 to FIG. 6. The description is used for explaining the embodiments of the present invention only, but not for limiting the scope of the claims.

As shown in FIG. 1, in one embodiment of the present invention, a drinking straw 100 is formed by a hollow tube 10 having two ends in fluid-communication with each other. The drinking straw 100 includes: an aluminum foil tubular layer 11 and a pulp tubular layer 12 which is attached to the aluminum foil tubular layer 11 in such a manner that one surface of the pulp tubular layer 12 completely overlaps on one surface of the aluminum foil tubular layer 11. Besides, the cross-sectional shape of hollow tube 10 can also be polygon such as round, square or star, etc. Moreover, a part of the hollow tube 10 can also be a bellows, which is easy to adjust the end direction by user.

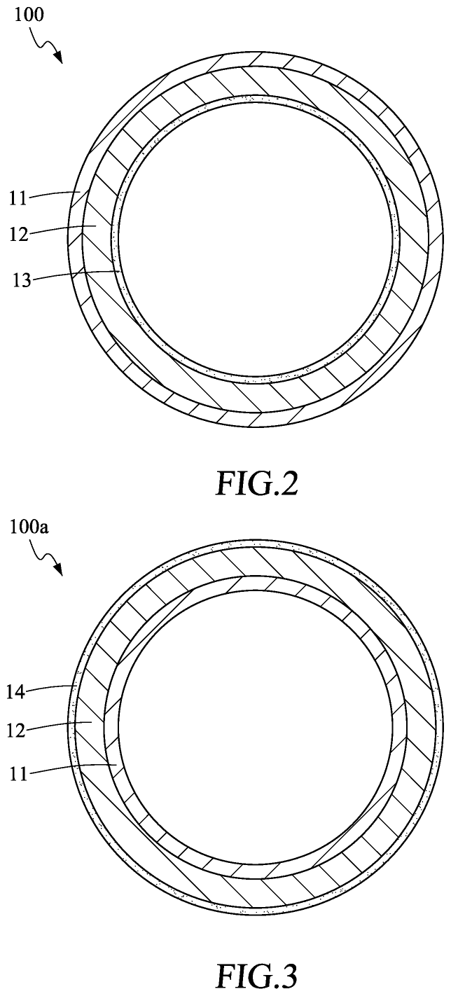

As shown in FIG. 2, in one embodiment of the present invention, a drinking straw 100 is provided that the inner surface of the aluminum foil tubular layer 11 is attached on the outer surface of the pulp tubular layer 12. With this kind of structure, the user's lips can directly contact the aluminum foil tubular layer 11 when he/she is drinking the cold beverage by the drinking straw 100. Because the thermal conduction efficiency of the aluminum foil tubular layer 11 is better than that of the pulp tubular layer 12, the user can quickly obtain the cool feeling by the aluminum foil tubular layer 11 accordingly.

As shown in FIG. 3, in one embodiment of the present invention, a drinking straw 100a is provided that the outer surface of the aluminum foil tubular layer 11 is attached on an inner surface of the pulp tubular layer 12. With this kind of structure, the user's lip can directly contact the pulp tubular layer 12 when he/she is drinking the hot beverage by the drinking straw 100a. Because the thermal insulation efficiency of the pulp tubular layer 12 is better than that of the aluminum foil tubular layer 11, the user's lip can be protected from scald. The aluminum foil tubular layer 11 also can keep the hot beverage in warm. Because the surface of the aluminum foil tubular layer 11 is more hydrophobic than that of the pulp tubular layer 12 to significantly reduce the friction of the inner surface of the drinking straw 100a, the user can smoothly drink the beverage by the drinking straw 100a, especially the viscous beverage.

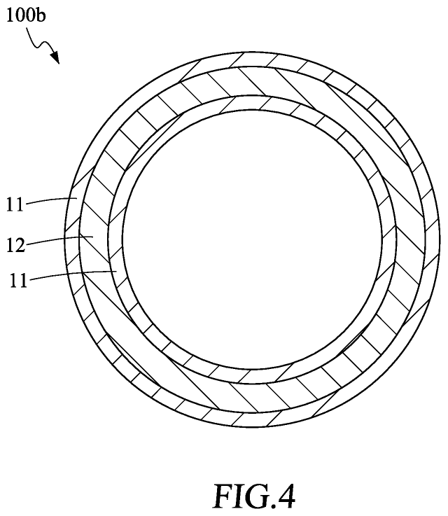

As shown in FIG. 4, in one embodiment of the present invention, a drinking straw 100b is formed with two aluminum foil tubular layers 11 and one pulp tubular layer 12. The one pulp tubular layer 12 is located between the two aluminum foil tubular layers. This kind of structure is conducive to excluding air effectively, keeping beverage fresh for a long time and preventing its deterioration caused by environmental conditions. On the other hand, the user's lips can directly contact aluminum foil tubular layer 11 when he/she is drinking the cold beverage by the drinking straw 100b. Because the thermal conduction efficiency of the aluminum foil tubular layer 11 is better than that of the pulp tubular layer 12, the user can quickly obtain the cool feeling by the aluminum foil tubular layer 11 accordingly. Furthermore, in this embodiment of the present invention, since the most internal and external layers of the drinking straw 100b are the aluminum foil tubular layers 11, the drinking straw 100b can be manufactured without any waterproof treatment so as to simplify the production process and reduce the production cost.

As shown in FIG. 2, in one embodiment of the present invention, a drinking straw 100 further includes an internal waterproof layer 13 which is attached on an internal surface of the pulp tubular layer 12. With this kind of structure, the occurrence of infiltration and destruction of the drinking straw 100 caused by the permeation of beverage from the pulp tubular layer 12 of the hollow tube 10 can be prevented when the drinking straw 100 is used to be drink beverage by a user. Preferably, a food grade wax can be used as the internal waterproof layer 13. Even if the beverage is hot, it will not induce the precipitation of the toxic substances. Preferably, Nano grade waterproof coating can also be used as the internal waterproof layer 13. The friction of the inner surface of the drinking straw 100 is able to be reduced significantly by the Nano grade waterproof coating due to its strong hydrophobicity, and therefore the user can drink a beverage smoothly by the drink straw 100, especially some viscous beverages.

As shown in FIG. 3, in one embodiment of the present invention, a drinking straw 100a further includes an exterior waterproof layer 14 which is attached on an outer surface of the pulp tubular layer 12. With this kind of structure, the occurrence of infiltration and destruction of the drinking straw 100a caused by the permeation of beverage from the pulp tubular layer 12 of the hollow tube 10 can be prevented when the drinking straw 100a is used to be drink beverage by the user. Preferably, a food grade wax can also be used as the exterior waterproof layer 14. Even if the beverage is hot, it will not induce the precipitation of the toxic substances.

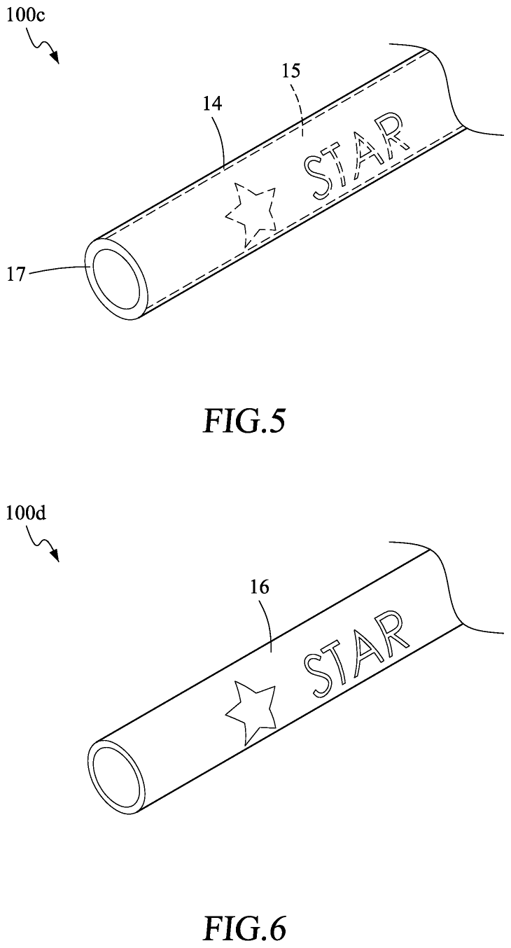

As shown in FIG. 5, in one embodiment of the present invention, a drinking straw 100c further includes a printed layer 15 formed on an outer surface of the drinking straw 100c. Specifically, the printed layer 15 can be formed on an outer surface of the drinking straw 100c by various printing methods, such as letterpress printing, gravure printing, planography printing or laser engraving. Furthermore, the printed layer 15 can be formed on the part of or the entire outer surface of the drinking straw 100c. Besides, the content of the printed layer 15 can be any text, any pattern, a text or a pattern pieced together by a plurality of the drinking straws.

As shown in FIG. 6, in one embodiment of the present invention, a drinking straw 100d further includes a waterproof printed layer 16. With this kind of structure, the exterior waterproof layer 14 is not required to be applied on the outer surface of the printed layer 15 of the drinking straw 100d. The present invention of this embodiment is preferable to be applied to a drinking straw having a printed layer formed only on a portion of its outer surface.

As shown in FIG. 5, in one embodiment of the present invention, a drinking straw 100c further includes an end waterproof layer 17 being formed on a periphery of each end of the hollow tube 10. The end waterproof layer 17 is used to prevent the liquid leaking from the end of the hollow tube 10 to the pulp tubular layer 12. since the leakage can cause the infiltration and destruction of the structure of the drinking straw 100c. Preferably, the end waterproof layer 17 is connected with the internal waterproof layer 13, the exterior waterproof layer 14 or the waterproof printed layer 16 to enable the drinking straw to be fully waterproof.

With the abovementioned structure, the drinking straws 100, 100a, 100b, 100c, and 100d of the present invention are simple and advantageous for mass production. Furthermore, the drinking straws 100, 100a, 100b, 100c, and 100d are formed by a multilayer structure which is closely attached on each other. With this kind of structure, the drinking straw is capable of not only keeping the basic strength in use, but also squeezing on impact to avoid any personal injury, such as piercing or cutting. On the other hand, the material of the drinking straw 100, 100a, 100b, 100c, and 100d of the present invention is natural and Eco-friendly. Besides, the recycled pulp also can be used as the material of the drinking straw so as to lower production cost.

The above description should be considered only as an explanation of the preferred embodiment of the present invention. A person with ordinary skill in the art can make various modifications to the present invention based on the scope of the claims and the above description. However, those modifications shall fall within the scope of the present invention.

What is claimed is:

1. A drinking straw being formed as a hollow tube having two ends in fluid-communication with each other, the drinking straw comprising:
an aluminum foil tubular layer; and
a pulp tubular layer attached to the aluminum foil tubular layer in such a manner that one surface of the pulp tubular layer completely overlaps on one surface of the aluminum foil tubular layer.

2. The drinking straw as claimed in claim 1, wherein an inner surface of the aluminum foil tubular layer is attached on an outer surface of the pulp tubular layer.

3. The drinking straw as claimed in claim 1, wherein an outer surface of the aluminum foil tubular layer is attached on an inner surface of the pulp tubular layer.

4. The drinking straw as claimed in claim 1, wherein the drinking straw is formed with two aluminum foil tubular layers between which the pulp tubular layer is formed.

5. The drinking straw as claimed in claim 2, further comprising an internal waterproof layer being attached on an internal surface of the pulp tubular layer.

6. The drinking straw as claimed in claim 3, the drinking straw further comprising an exterior waterproof layer being attached on an outer surface of the pulp tubular layer.

7. The drinking straw as claimed in one of claim 1, further comprising a printed layer formed on an outer surface of the drinking straw.

8. The drinking straw as claimed in one of claim 6, further comprising a printed layer formed on an outer surface of the drinking straw.

9. The drinking straw as claimed in claim 7, further comprising an exterior waterproof layer being attached on the outer surface of the printed layer.

10. The drinking straw as claimed in claim 8, further comprising an exterior waterproof layer being attached on the outer surface of the printed layer.

11. The drinking straw as claimed in claim 7, wherein the printed layer is a waterproof printed layer.

12. The drinking straw as claimed in claim 8, wherein the printed layer is a waterproof printed layer.

13. The drinking straw as claimed in one of claim 1, further comprising an end waterproof layer being formed on a periphery of each end of the hollow tube.

14. The drinking straw as claimed in one of claim 2, further comprising an end waterproof layer being formed on a periphery of each end of the hollow tube.

15. The drinking straw as claimed in one of claim 3, further comprising an end waterproof layer being formed on a periphery of each end of the hollow tube.

16. The drinking straw as claimed in one of claim 4, further comprising an end waterproof layer being formed on a periphery of each end of the hollow tube.

17. The drinking straw as claimed in one of claim 5, further comprising an end waterproof layer being formed on a periphery of each end of the hollow tube.

18. The drinking straw as claimed in one of claim 6, further comprising an end waterproof layer being formed on a periphery of each end of the hollow tube.
